(19) United States
(12) Patent Application Publication
(10) Pub. No.: US 2004/0260921 A1
(43) Pub. Date: Dec. 23, 2004

(54) Cryptographic method, system and engine for enciphered message transmission

(76) Inventor: William S. Treadwell, Alexandria, VA (US)

Correspondence Address: TIMOTHY J MARTIN, PC, 9250 W 5TH AVENUE, SUITE 200, LAKEWOOD, CO, 80226, US

(21) Appl. No.: 10/760,711

(22) Filed: Jan. 20, 2004

Related U.S. Application Data
(63) Continuation-in-part of application No. 10/200,014, filed on Jul. 18, 2002.

(51) Int. Cl. H04L 9/00

(52) U.S. Cl. 713/150

(57) ABSTRACT

A method for preparing enciphered message transmission over a network architecture entails receiving plain text data corresponding to the message, passing the plaintext data to a multi-tiered encryption engine, encrypting the plaintext data according to a first encryption scheme to generate first ciphertext message data, and encrypting the first ciphertext message data according to a second encryption scheme to generate second ciphertext message data intended for transmission. Also provided is a cryptographic system, multi-tiered encryption/decryption engine(s) and a computerized method for enciphered message transmission.

### FIELD OF THE INVENTION

The present invention broadly relates to the field of network computer communications. More particularly, the present invention concerns those communications which take place between computer systems residing as clients on a private network, such as an organization's LAN or WAN. The present invention is even more specifically directed to cryptographic methods, systems and engines for providing multiple layers of data encryption and data decryption at the application layer of a protocol suite to provide secure communications between computer systems.

### BACKGROUND OF THE INVENTION

The incredible growth of distributed computer system networks has allured businesses and individuals alike with unprecedented capabilities for affecting the way we live and work. Attendant with these incredible capabilities, however, is that distributed computer networks need to be adequately secured, particularly for those transmitting sensitive information such as credit card data, social security numbers, private correspondences, and financial information, to illustrate a few. Indeed, the success of many modern day businesses is intimately contingent upon their ability to gain a competitive advantage by offering e-commerce transactions which are implemented in a secure environment so that customers are confident their transactions remain secure. Although network security is undoubtedly a concern for unsecured networks, such as the internet, security is of equal importance to those operating in other network environments, such as intranets, extranets, virtual private networks (VPNs), or any other type of network environment where privacy and authenticity is of interest.

Security threats to distributed networks can generally be categorized as internal or external. High profile organizations can be particularly susceptible to external threats because each system is potentially vulnerable unless it is completely isolated from the outside. Some hackers infiltrate systems for monetary gain or as some form of corporate or international espionage, while others simply break into systems for the challenge. Internal security threats often come from disgruntled employees or implants.

Modern security practices implement layers of physical, administrative, electronic and cryptographic systems to protect valuable resources against known or unknown vulnerabilities. While physical security remains an important factor, modern distributed networks pierce physical structures. Prudent administrative practices can be vital to a network's security because even the most powerful intrusion protection or encryption systems can be useless if people don't properly protect their passwords, key cards, or other identifying information. Indeed, many security systems fail due to poor or inadequate administrative practices.

Even though the growth of computer networks can strain the capabilities of known security architectures, network security management tools, such as perimeter protection, anti-viral protection, encryption and intrusion detection, are constantly being devised, revised and deployed to secure communications. Cryptographic systems, in particular, are widely used to ensure privacy and authenticity of messages communicated over insecure channels. Data encryption is grounded in the science of cryptography, which has been used throughout history to encode messages. Encryption is the process of encoding information in such a way that only the recipient (person or computer) with the appropriate key can decode the data. Accordingly, encryption alters data from an unenciphered or plaintext form to an enciphered or ciphertext form so that it is essentially meaningless to anyone other than the intended recipient. Today's computerized Crypto systems utilize crypto keys, which are secret values computer used in concert with complex mathematical formulas called crypto algorithms to encrypt and decrypt messages.

Two types of common encryption systems prevail—secret key cryptography, often referred to as symmetric encryption, and public-key cryptography, often referred to asymmetric encryption. As well documented, in a packet-switched network utilizing symmetric encryption each computer has a secret key or code that is used to encrypt data packets as they are transmitted over the network. Symmetric key encryption requires that each party to the communication be privy to the secret key in order to encode and decode the information. In public key cryptography on the other hand, each computer system has an associated public key that is available to others, as well as an associated private key which is kept secret on the client systems. Cryptographic systems which implement public key cryptography to ensure privacy and authenticity of messages are also extensively documented, as evidenced for example by those systems which are the discussed in U.S. Pat. No. 4,218,582 to Hellman et al. and U.S. Pat. No. 4,200,770 to Hellman et al.

Widely known also are public key infrastructures (PKIs) which implement the asymmetric encryption approach to message authentication and security. A PKI often involves certificate management systems implemented via certificate authorities (CAs) and registration authorities (RAs). A certificate authority issues digital certificates to authenticate the identity of individuals and organizations over a public system, such as the Internet. A registration authority acts as the verifier for the certificate authority before a digital certificate is issued to a requester. In a typical public key infrastructure, public and private key pairs are created simultaneously by a CA using the same hashing algorithm, RSA presently being the most common. A number of products are available for implementing a PKI, and the acceleration of e-commerce and business-to-business commerce over the Internet has increased the demand for such products. PKI related vendors include RSA, VeriSign, Inc., GTE CyberTrust, Xcert, and Netscape, to name a few. One particular product which is increasingly popular is known as pretty good privacy (PGP) and allows for secure transmission and authentication of e-mail data.

Various security protocols have emerged for securely transmitting data on distributed networks. Recognizable ones include Secure Sockets Layer (SSL) available from Netscape, SHTTP available from NCSA, Microsoft's PCT and the Internet Engineering Task Force's (IETF) IPsec. Presently, SSL is the leading security protocol for the Internet and has become the de facto standard for secure communications between end users and Internet sites. The SSL protocol interfaces neatly within the TCP/IP protocol stack between the application layer and the TCP layer. As such, SSL is an application independent protocol and higher-level protocols, such as HTTP, can layer on top of it transparently. SSL advantageously provides connection security having the basic properties of privacy, authenticity and reliability. Public key cryptography is used during the SSL handshake protocol to negotiate an encryption algorithm and cryptographic keys before the application protocol transmits or receives data. Symmetric cryptography is generally then used to encrypt the data according to an encryption algorithm (e.g., DES,RC4, etc.). Identity authentication is accomplished by using asymmetric cryptography (e.g. RSA,DSS etc.). Message integrity can be confirmed using a keyed message authentication code (MAC) and secure hash functions (e.g. SHA, MD5, etc.) are often used for MAC computations. The SSL record protocol is layered on top of a reliable transport protocol, such as TCP, and is used for encapsulation of various higher-level protocols.

Implementations of cryptographic systems such as SSL can be quite effective at transforming the application layer's plaintext data into a ciphertext format which is extremely difficult or infeasible for an unauthorized party (eavesdropper) to recreate without access to the cipher key(s). Such systems, though, do not adequately prevent access to the cipher key(s) by someone, such as an administrator on a private network, having root access to system resources.

For many organizations, the potential threat associated with an administrator, who is in fact a snoop, cannot be overlooked. Even though an administrator with root level access to systems may be an authorized user on a private network, which may or may not be completely isolated from other networks, he or she is nonetheless an unauthorized party to an internal communication between clients systems who desire private communication. The administrator might have access to all of the public and private keys for authorized users of the network. For example, if the certificate authority (CA), or even the registration authority (RA) in a public-key infrastructure is managed internally, then digital certificates with public and private keys become accessible to an administrator of the CA or RA. With this information alone, an unauthorized party over time can peel away the security system to obtain the once-thought secure session key, and ultimately decipher the underlying communication. Perhaps assisting the eavesdropper in his/her surreptitious activity is that many distributed computer networks retain logs of network activity on host servers and many host browsers (or the end points of the communications) store session keys locally for a finite period of time after the session has been terminated, which may be sufficient to abscond with the key.

Over time, virtually any system can be infiltrated so the scale of security protection schemes is often matched against the value of the information and the potential threat. However, known encryption schemes, such as those discussed herein, are believed to lack sufficient security to ensure against the detection of the cipher keys themselves by dedicated eavesdroppers. Accordingly, there remains a need to improve security associated with network transmissions in this regard, and the present invention is particularly directed to addressing this need.

### SUMMARY OF THE INVENTION

It is an object of the present invention to provide a method of preparing a message for enciphered transmission over network architecture from a sending computer system to a receiving computer system.

It is also an object of the present invention to improve upon known methods for communicating enciphered message data between computer systems along a network architecture which operates according to a layered communications protocol, such as the layered TCP/IP protocol suite.

Another object of the present invention is to provide a new and improved cryptographic system for permitting enciphered message transmission between first and second computer systems on a network architecture.

Still a further object of the present invention to provide a multi-tiered encryption and/or decryption engine for use on a sending computer system, namely a client computer system on the network architecture.

It is yet another object of the present invention to provide such cryptographic methods, systems and engines which make infeasible or practically impossible for an eavesdropper to decipher encrypted message transmissions, even if the eavesdropper is another authorized user of the network, such as a network administrator, who has root assess to system resources.

In accordance with these objectives, one advantageous embodiment of the present invention relates to a method of preparing a message for enciphered transmission over a network architecture from a sending computer system to a receiving computer system which are adapted to communicate according to a layered communications protocol. Such as a communications protocol is characterized by a protocol stack, such as the known layered TCP/IP protocol suite. In accordance with this broad methodology, various operations take place at the sending computer system. Plain text data is received from an application program, with the plain text data corresponding to a message intended to be transmitted. The plain text data is passed to a multi-tiered encryption engine stored on the computer system which encrypts the plain text data according to a first encryption scheme, thereby to generate first ciphertext message data. The first ciphertext message data is then encrypted according to a second encryption scheme, thereby to generate second ciphertext data intended for transmission to the receiving computer system in accordance with the layered communications protocol. The second ciphertext data may then be delivered directly to a transport layer associated with the communications protocol, such as the insecure transport layer of TCP/IP. Alternatively, the second ciphertext data may be passed to a secure sockets layer (SSL) before being delivered down the protocol stack to the transport layer.

Advantageously, the first encryption scheme may comprise asymmetric cryptography which encrypts the plain text data according to a first encryption algorithm utilizing a first encryption key associated with a user of the receiving computer system. In the illustrated embodiment of this first encryption scheme, the encryption key is a public key associated with an authorized user of the receiving computer system. As for the second encryption scheme, it can advantageously be initiated upon entry of a selected pass phrase. Preferably also, the second encryption scheme is implemented in accordance with a pre-defined cryptographic scheme that includes a pre-defined encryption algorithm residing on the sending computer system. When the message to be transmitted is not in the form of a file, it is preferred that the first and second encryption schemes be sequentially implemented as discussed. However, when the message is in the form of a file, it is preferred that the encryption schemes be reversed so that the plain text data is initially encrypted in accordance with the pass-phrase initiated encryption scheme, and thereafter converted to associated second ciphered text data in accordance with asymmetric cryptography.

Advantageously, each of the encryption algorithms may be conveniently stored in a common database on the sending computer system, such as in a dynamically linked library (DLL). The pass-phrase initiated encryption scheme preferably comprises an associated encryption algorithm which is selected from this database so that it may be changed if desired. Such algorithms may include 3DES, AES and Blowfish, to name only a few.

Another advantageous embodiment of the present invention relates to a computerized method for transmitting an enciphered message from a sending client computer system to a receiving client computer system, which are each logged onto a common network server. In accordance with this methodology, plain text data corresponding to a message is obtained at the sending computer system. The receiving computer system is identified as an intended recipient of the message and a confirmation is made that the receiving computer system is valid. Validation of the receiving computer system simply means that it has not been identified as an unauthorized user of the encryption resources. The plaint text data is passed to a multi-tiered encryption engine located at the sending computer system where it is encrypted according to a first encryption scheme, thereby to generate the first ciphertext message data. The first ciphertext message data is encrypted again according to a second encryption scheme to generate the second ciphertext message data. The second ciphertext message data is then passed down the protocol stack to a TCP/IP transport layer after which it is transmitted, via the server, to the receiving computer system in accordance with TCP/IP.

Once the enciphered message reaches its destination, in accordance with known transmission techniques, it is passed up the protocol stack at the receiving computer system from TCP/IP to a correspondingly configured application layer, multi-tiered decryption engine. Upon execution of the decryption engine, the second ciphertext message data is reverted to the first ciphertext message data according to a first decryption scheme and thereafter reverted to the plain text data according to a second decryption scheme. This plain text data is then delivered to an application program accessible by the receiving computer system.

A multi-tiered encryption engine is also provided for use on a sending computer system. The multi-tiered encryption engine comprises first and second encryption modules each implemented in user space. The first encryption module receives plain text data from an application program and encrypts the plain text data according to a first encryption scheme to generate the first ciphertext data, while the second encryption module encrypts the first ciphertext data to second ciphertext data according to a second encryption scheme. Here again, it is preferred, although certainly not required, that the first encryption scheme implement asymmetric cryptography, while the second encryption scheme utilize a required pass-phrase for implementation.

The present invention also advantageously provides a cryptographic system for permitting enciphered message transmission between the first and second computer systems on a network architecture. A multi-tiered encryption engine as discussed above is implemented on the first computer system. Implemented on the second computer system is a multi-tiered decryption engine. The decryption engine comprises a first decryption module for receiving the second ciphertext data from the transport layer of the second computer system and for reverting the second ciphertext to first ciphertext data according to a first decryption scheme. A second decryption module reverts the first ciphertext data to the plain text data according to a second decryption scheme and delivers the plain text data to an application program accessible by the second computer system.

To further permit the second computer system to initiate and transmit enciphered message transmission to the first computer system, a corresponding multi-tiered encryption engine is stored on the second computer system, while a corresponding multi-tiered decryption engine is stored for execution on the first computer system. Preferably, the first encryption module and the second decryption module are implemented according to a common cryptographic scheme, and the same holds true for the second encryption module and first decryption module.

Finally, the present invention also provides an improvement to a known method of communicating enciphered message data from a sending computer system to a receiving computer system, wherein the known method is implemented according to a layered communications protocol of a type which implements a security protocol, such as SSL, to provide a secure channel for communicating between the computer systems. In accordance with this improvement, a multi-layered encryption engine as discussed above is implemented at the application layer of the sending computer system.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a diagrammatic view illustrating a first exemplary embodiment of a cryptographic system according to the present invention;

FIG. 2 is a diagrammatic view illustrating the multi-tiered encryption engine of the present invention and its functional association within the layered TCP/IP protocol suite;

FIG. 3 is a diagrammatic view for illustrating possible fragmentation and encryption of message data as it is passed down the layer TCP/IP protocol stack represented in FIG. 2, and additionally envisions delivery of encrypted data to an SSL encryption module, such as when the cryptographic system of the present invention is implemented in accordance with the second exemplary embodiment illustrated in FIG. 4;

FIG. 4 is a diagrammatic view illustrating a second exemplary embodiment of a cryptographic system according to the present invention;

FIG. 5 is a diagrammatic view illustrating a third exemplary embodiment of a cryptographic system according to the present invention;

FIG. 6 is a block diagram for broadly illustrating the principal concepts associated with each of the various embodiments of the cryptographic systems of FIGS. 1, 4 & 5 when implemented as two-way communication systems;

FIG. 7(a) diagrammatically illustrates a server engine for use with an insecure transport layer implementation of the present invention;

FIG. 7(b) diagrammatically illustrates a server engine for use with a secure transport layer implementation of the present invention; and

FIG. 8 is a high level flowchart for illustrating the process which takes place at the sending computer system in order to prepare a plain text message for enciphered transmission to a receiving computer system via a network server.

### DETAILED DESCRIPTION OF THE EXEMPLARY EMBODIMENTS

The present invention is derived, in part, from an assumption that the only trusted parties to a communication are the authorized conversers, even though there may be other authorized users on the network. This specifically contemplates, for example, that a communication cannot be deemed sufficiently secure unless measures are taken to prevent even authorized users of a network with access to pertinent network resources, for example administrators with root level access, from deciphering the transmission.

Various terms are used throughout the application which should have conventional meanings to those familiar with operating system environments, particularly Unix, as well as systems administration and network security. Of particular interest to the present invention are the following:

Layered Communications Protocol: The hardware and software standards governing data transmission between computers, including the packet structure of the data transmitted or the control commands for managing the session, or both. The term encompasses numerous different types of known data transmission methods, of which the layered TCP/IP protocol suite is a representative example, as well as future versions of them.

Connection: A logical communication path identified by a pair of sockets.

Datagram: Also referred to as a packet, this is the unit of data transmitted in a packet switched computer communications network, such as one implementing TCP/IP. Each datagram contains source and destination addresses and data. As such, an Internet datagram is then the unit of data exchanged between an Internet layer and the higher-level protocol together with the Internet header.

Fragment: A portion of a logical unit of data. Thus, an Internet fragment is a portion of the data of an Internet datagram, along with an Internet header.

Header: Control information at the beginning of a segment, fragment, packet or block of data.

Host or client: A computer system, particularly one that is a source or destination of messages from the point of view of the communication network.

Message The term encompasses any type of information, such as an instant message, a selected type of file, biometric or other suitable information, which is intended to be communicated from one computer system to another, i.e. network conversers.

Module: An implementation, usually in software, of a protocol, such as SSL, or a particular procedure, such as encryption or decryption.

Network Architecture: Used interchangeably with the term “Network Infrastructure” to refer to the design of a communications system, which includes the backbones, routers, switches, wireless access points, access methods and protocols used.

Packet: A package of data with a header which may or may not be logically complete. More often a physical packaging than a logical packaging of data.

Payload: A part of a packet or frame in a communications system that holds the message data in contrast to the headers, which are considered overhead.

Security Protocol: A communications protocol, such as SSL, that encrypts and decrypts a message for online transmission. Security protocols generally also provide authentication.

Segment: A logical unit of data, in particular a TCP segment is the unit of data transferred between a pair of TCP modules.

Socket: An address which specifically includes a port identifier, that is, the concatenation of an Internet Address with a TCP port.

TCP/IP suite or TCP/IP protocol suite: These interchangeable terms are to be understood as described in “TCP/IP Illustrated” by Richard Stevens, Addison-Wesley Publishing Co., (1^{st} ed. 1993).

In its preferred form, the present invention is implemented on a user's computer system which resides as a client on a network architecture permitting message communication with other client according to a layered communications protocol. Such a client computer system has a network interface and typically includes an input device such as a keyboard, a display device such as a monitor, and a pointing device such as a mouse. The computer also typically comprises a random access memory (RAM), a read only memory (ROM), a central processing unit (CPU), and a storage device. The storage device may be a large-capacity permanent storage such as a hard disk drive, or a removable storage device, such as a floppy disk drive, a CD-ROM drive, a DVD-ROM drive, flash memory, a magnetic tape medium, or the like. However, the present invention should not be unduly limited as to the type of computer on which it runs, and it should be readily understood that the present invention indeed contemplates use in conjunction with any appropriate information processing device, such as a general-purpose PC, a PDA or the like.

Source code for software which implements aspects of the present invention was developed on a Windows machine utilizing Borland's C++ Builder© compiler as the development tool. Of course, the source code could be readily adapted for use with other types of operating systems, such as Unix or DOS, to name only a few, and may be written in one of several widely available programming languages with the modules coded as sub-routines, sub-systems, or objects depending on the language chosen. In addition, various low-level languages or assembly languages could be used to provide the syntax for organizing the programming instructions so that they are executable in accordance with the description to follow. Thus, the preferred development tools utilized by the inventor should not be interpreted to limit the environment of the present invention.

The software embodying the present invention may be distributed in known manners, such as on various types of computer-readable media, or over an appropriate communications interface so that it can be installed on client and server computer systems. Furthermore, alternate embodiments of the invention which implement the system in hardware, firmware or a combination of both, as well as distributing the modules and/or the data in a different fashion, will be apparent to those skilled in the art. It should, thus, be understood that the description to follow is intended to be illustrative and not restrictive, and that many other embodiments will be apparent to those of skill in the art upon reviewing the description.

In the following detailed description, reference is made to the accompanying drawings which form a part hereof, and in which is shown by way of illustrations specific embodiments of the invention. The leading digit(s) of the reference numbers in the figures usually correlate to the figure number, with the exception that identical components which appear in multiple figures are identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined only by the appended claims.

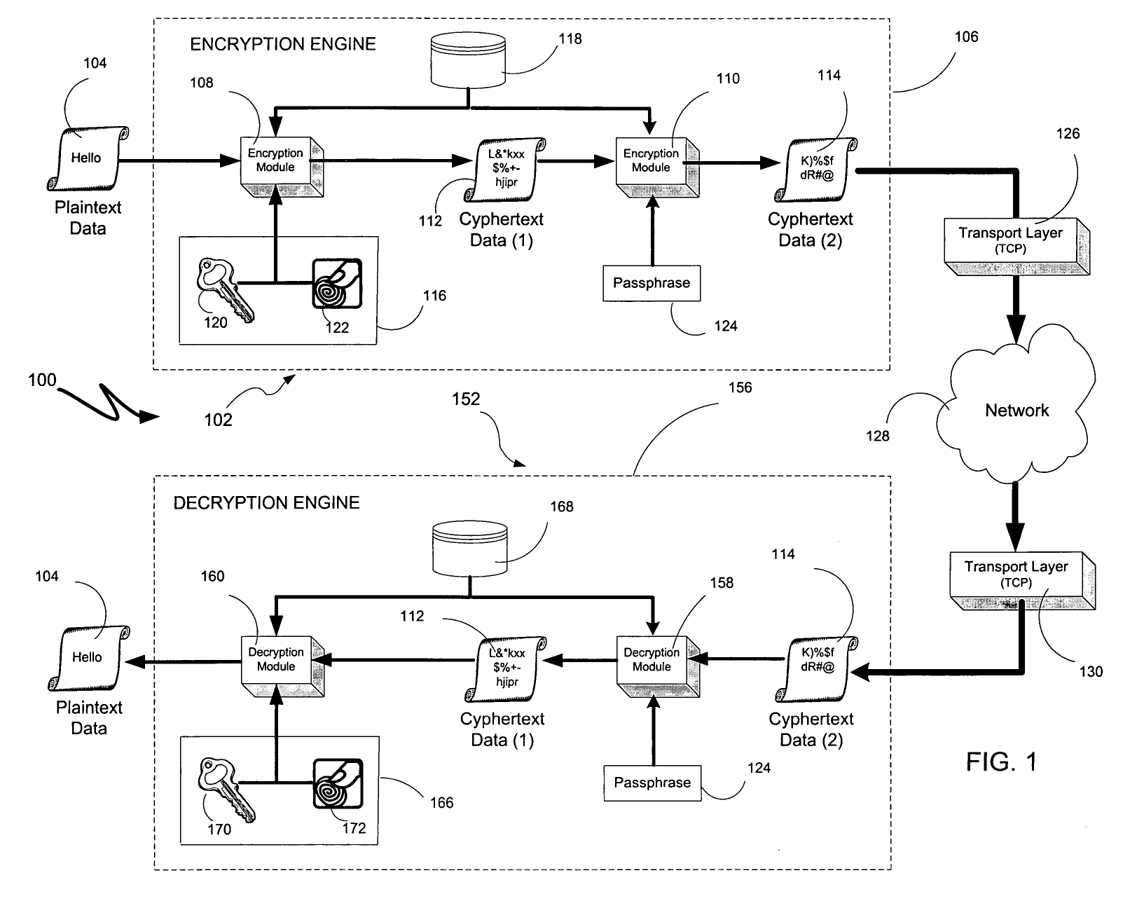

With the above in mind, a first advantageous embodiment of a cryptographic system 100 according to the present invention is shown in FIG. 1. Cryptographic system 100 permits enciphered data corresponding to plain text messages to be transmitted securely across a network architecture between sending and receiving computer systems. Primarily, the various embodiments of the present invention will be described in the context of an instant message (IM) which is to be securely transmitted from a sending computer system to a receiving computer system, each residing as a node on the network. Accordingly, in FIG. 1 a first computer system 102 is depicted as a transmitter of message data, and thus identified as the sending computer system. Second computer system 152 is the intended recipient of the message data and will, thus, be identified as the receiving computer system. In a preferred embodiment of the cryptographic system, each of these computer systems 102 and 152 is validated by an associated network server as an authorized user of those network resources required to implement message transmission. However, it is to be understood that, while the preferred embodiments of the present invention are discussed with reference to a client server network infrastructure, the principle features of the present invention could readily be implemented on a more rudimentary network infrastructure which, in its simplest form, can be characterized as having only two computer systems (sending and receiving) which are capable of conversing directly with one another via a communication pathway having a single link.

At the sending computer system 102, plain text data 104 corresponding to a message to be transmitted, such as the word “hello”, is acquired through any of a variety of known manners. The plain text data 104 is sent to an encryption engine 106 preferably located on the sending computer system 102 so that is can be enciphered prior to transmission to receiving computer system 152. Within encryption engine 106, the plain text data 104 encounters two encryption modules 108 and 110 prior to being delivered down the remainder of the protocol stack. After being passed to the first encryption module 108, the plain text data 104 is converted to first cyphertext data 112. This first cyphertext data 112 is passed to second encryption module 1 10 where it is converted to second cyphertext data 1 14.

Each of encryption modules 108 and 110 converts its respective incoming data stream to cyphertext data according to an associated encryption scheme. Where the plain text data 104 is in the form of an instant message as discussed, it is preferred that first encryption module 108 implement an asymmetric cryptographic scheme so that the incoming plain text data 104 is converted to the cyphertext data 110 utilizing the popular RSA encryption algorithm. That is, first encryption module 108 encrypts data 104 utilizing an encryption key 116 which is unique to an authorized user of receiving computer system 152. This first encryption key 116 is utilized in conjunction with the RSA encryption algorithm which may be conveniently stored on the sending computer system 102 in a database 118 in any of a variety of known manners. The RSA encryption algorithm, as well as others discussed herein, can be purchased from various distributors and readily integrated into a programming environment as part of an application program so that they are available for execution when called.

For representative purposes only, the first encryption key 116 which is unique to receiving computer system 152 may be in the form of a public key 120 or a biometric identifier such as a fingerprint 122. For example, a template corresponding to a fingerprint scan, iris scan or voice scan associated with a user of receiving computer system 152 can be made available to the sending computer system 102 so that it is stored thereon and readily accessible when the first tier encryption module 108 is executed. Transmission of the exchanged key can be done in a variety of known manners ranging from sending it via email, in a digital certificate if it is a public key, posting it to a website, copying and distributing it on a floppy disk, or even embedding within a hardware device. Regardless of how the exchange occurs, it preferably takes place prior to implementation of a cryptographic methodology discussed herein, such as, for example, when the appropriate application programs are initially installed on the computer systems.

Second tier encryption module 110 is initiated in response to entry of a required pass phrase 124 which, in the preferred form of the invention, is a pre-defined code known to both the sending and receiving computer systems. Entry of pass phrase 124 for initiating the second encryption module 110 can take place in a variety of ways, such as through keystrokes on a keyboard, voice transmission, a pass card, etc. The second encryption scheme associated with encryption module 110 effectuates encryption of the first cyphertext data 112 according to a pre-defined encryption algorithm that is selected from a set of appropriate encryption algorithms that may also be stored within database 118. A variety of known encryption algorithms such as 3DES, RC4, Blowfish, Twofish, AES and DES, to name only a few, could be employed. Alternatively, the pre-determined encryption algorithm could be customized by an administrator so that it is unique to the conversers on the network architecture. Regardless of the particular algorithm employed for the second encryption scheme, it is desirable that it be pre-determined, for example, by selecting it when the application program is initially loaded on the computer systems. Of course, if desired, a different encryption scheme could be selected by overriding the pre-defined scheme. It is preferred, though, that this capability only be allowed to one with root access to system resources, likely the systems administrator.

Once the second cyphertext data 114 is generated, it is transmitted to the receiving computer system 152. More particularly, second cyphertext data 114 may be delivered down the protocol stack directly to a transport layer 126, such as TCP, where it can be fragmented and encapsulated according to the TCP protocols. It is then delivered to the remaining layers, i.e. the network and internet layers, and routed along the network to the receiving computer system's network and internet layers. This is collectively represented by the network cloud 128 in FIG. 1.

Once the enciphered message data 114 reaches receiving computer system 152 it is delivered up the protocol stack to the receiving computer system's transport layer (TCP) 130 and to a decryption engine 156 preferably located on receiving computer system 152. The cyphertext data 114 is sequentially reverted to the plain text message 104 at the receiving computer system 152. That is, cyphertext data 114 is delivered to a first decryption module 158 associated with decryption engine 156. First decryption module 158 operates to revert the cyphertext data 114 to first cyphertext data 112 according to an associated first decryption scheme that corresponds to the second encryption scheme associated above with reference to sending computer system 104. Accordingly, an associated first decryption algorithm, which may also be stored in a database 168 on the receiving computer system 152, executes upon entry of pass phrase 124 by a user of the receiving computer system 152.

Once the first cyphertext data is generated, it is delivered to a second decryption module 160. Second decryption module 160 necessarily implements asymmetric cryptography to revert cyphertext data 112 into the plain text data 104 through the use of an associated second-tier decryption key 166. Here, and in accordance with the RSA key exchange, the second-tier decryption key 166 is theoretically known only to a user of receiving computer system 152 and unique to him/her. Such a unique second decryption key may, for representative purposes only, be a private key 170 generated as part of the public/private key pair referred to above, or unique biometric scan data as represented by the fingerprint 172 in FIG. 1. Again, the biometric information can be fingerprint date, iris scan, voice recognition, etc. The private key 170 may be stored in a memory location on receiving computer system 152, as well as a template file pertaining to the biometric scan. Alternatively, the biometric data 172 can be provided at run time so that the authorized user of receiving computer system 152 has to physically activate a biometric scan in order to initiate second decryption module 160. Once second decryption module 160 has executed, the first cyphertext data 112 is reverted to the original plain text data 104 and delivered to an application program available by the receiving computer system 152 so that it may be viewed by the user.

As mentioned above, the features illustrated in FIG. 1 can be applied in different types of applications other than instant messaging, as should be readily apparent to the skilled artisan. One such application is for ensuring the secure entry into a facility. Assume, for instance, that an employee wishes to gain entry into a building through an entrance which incorporates a data transmission system mounted on the exterior of the building and a server located inside the building for communicating with the data transmission system. In FIG. 1 above, the data transmission system would correspond to sending computer system 102, while the server would correspond to receiving computer system 152. The data transmission system and the server each have an associated public/private key pair that, for example, might be assigned by the systems administrator, with each having access to the other's public key. With reference again to FIG. 1, the server's public key corresponds to box 116 and the server's private key corresponds to box 166. The keys used by the data transmission system, which might incorporate a processing module contained in a housing enclosure on the exterior door frame, could be permanently stored in hardware on the device.

When the employee approaches the entrance, a biometric reading device takes a biometric scan of the individual, e.g. an iris scan, to generate a corresponding data template. This data template correlates to the plaintext data 104 illustrated in FIG. 1. The biometric reading device, which is part of the external data transmission system, transmits the data template to the processing module, which is programmed to encrypt the template according to an encryption algorithm, e.g. Triple-DES, utilizing the server's public key. This would correspond to first encryption module 108 in FIG. 1 which generates first ciphertext data 112.

Also part of the external data transmission system could be a numeric keypad in communication with the processing module. This keypad can be used by the employee to enter a pass phrase corresponding to numeral 124 in FIG. 1. This pass phrase is also stored on the server for decryption purposes. It should be understood though, that the pass phrase does not have to correspond to data actually input by the employee; instead it could be something which is transparent to the user, such as a code that is either permanently or semi-permanently stored in memory on the module. In any event, assuming the correct pass phrase is entered by the individual, it is used to implement a second layer of encryption against the first ciphertext, thereby generating second ciphertext data corresponding to numeral 114 in FIG. 1. This second layer encryption scheme also resides in memory on the data transmission system as part of it overall encryption engine.

At this point, the second ciphertext is transmitted to the internal sever via conventional insecure transport means, which then decrypts it in accordance with the discussion above to reproduce the original data template corresponding to the employee's iris scan. This data template can then be matched against a data base of employee templates to determine whether the employee is authorized to enter the facility. If so, access is granted.

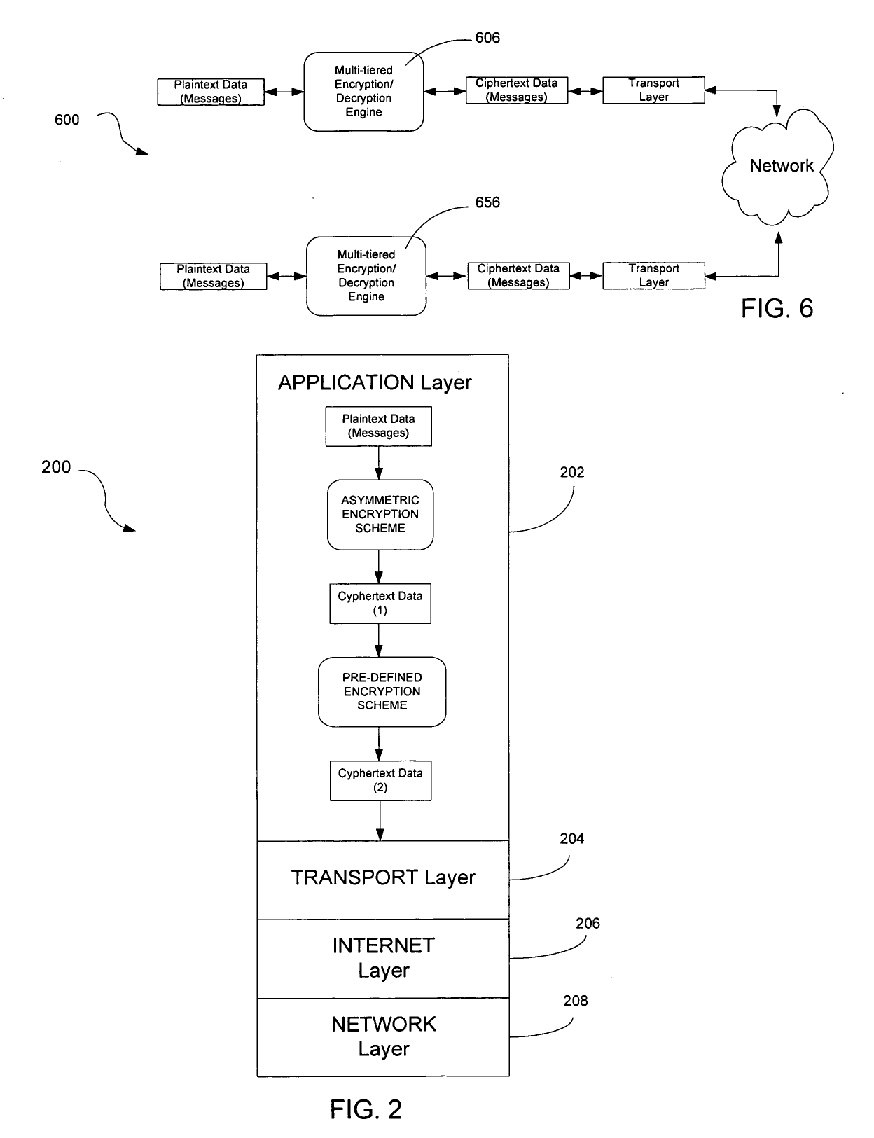

Having described the principle concepts associated with cryptographic system 100, reference is now made to FIG. 2 to illustrate how the sending computer system's encryption engine 106 interfaces within the layered TCP/IP protocol suite, which is the preferred layered communications protocol for implementation of the cryptographic system 100. As well known, the layered TCP/IP protocol stack as represented by numeral 200 includes four layers, namely, the application layer 202, the transport layer 204, the internet layer 206 and the network interface layer 208. Encryption engine 106 is an application layer engine so that, in the embodiment illustrated in FIG. 1, it delivers the cyphertext data directly to transport layer 204 after execution of the second tier encryption. An alternative embodiment, as discussed below with reference to FIG. 6, contemplates that the second cyphertext data 114 can pass to an application layer SSL (or TLS) implementation prior to delivery to the transport layer. In still another embodiment which is only disclosed herein but not the subject of the claims of the present application, a secure TCP transport layer is provided whereby various fields within the TCP headers are encrypted according to a security protocol which can be distributed as part of, or in addition to, an operating system's installation media so that it can be loaded into the kernel when the machine is booted. For purposes of distinction, this is referred to as the “secure transport layer implementation” which implements a secure exchange transport protocol and internet protocol, or SETP/IP for short. Because present implementations of the various protocols within TCP/IP do not provide for encryption of packet headers at the transport layer, it is preferred that transport layer 204 for purposes of the present invention be insecure to comport with standardizations in the art.

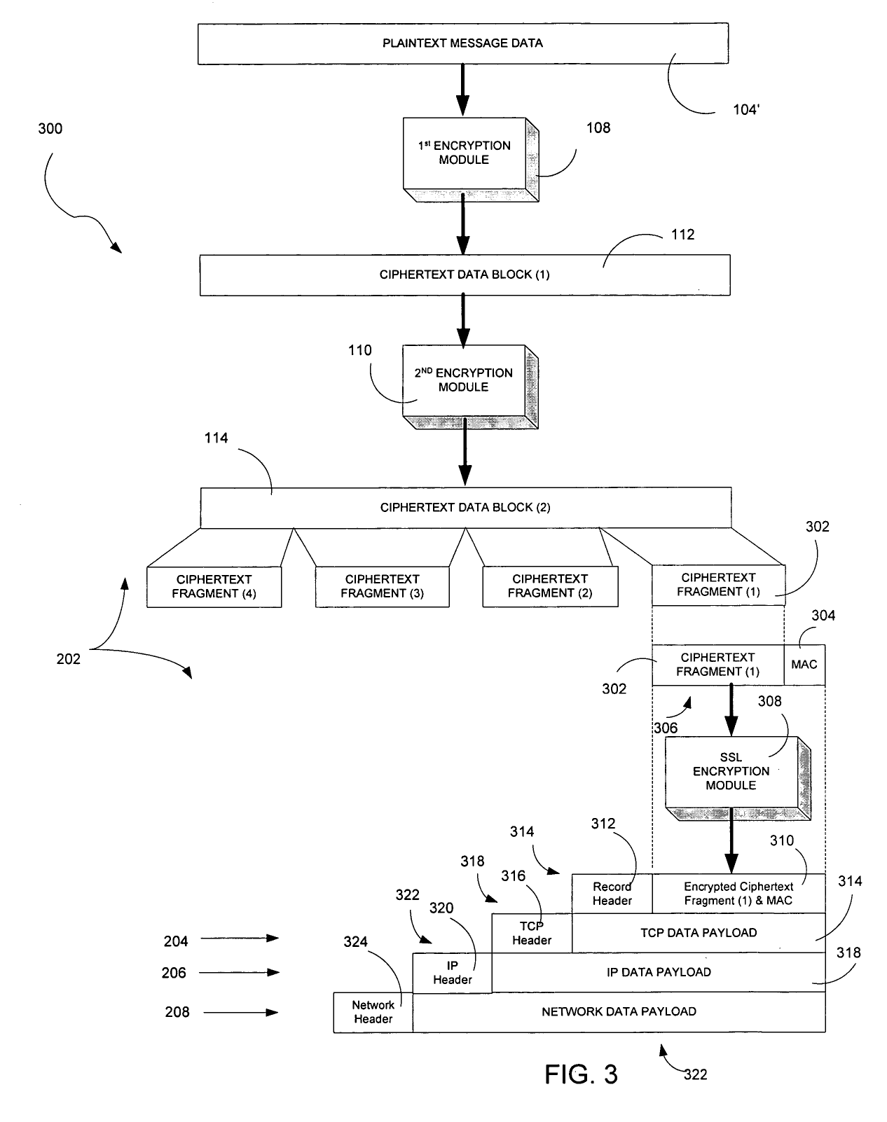

With an appreciation of the functional placement of the encryption engine 106 within the layered TCP/IP protocol stack, reference is now made to the diagrammatic view of FIG. 3 to illustrate one possible manner in which the message data might be fragmented and encrypted as it is delivered down the protocol stack within the sending computer system before delivery to the recipient along the network wires. For illustrative purposes only, this 300 contemplates that the message to be transmitted is sufficiently large that it will need to be broken down into fragments according to known techniques in order to be properly routed within the network. With this in mind, a representatively large plain text message data 104′ is passed to the first tier encryption module 108 as discussed above which preferably encrypts it according to public key cryptography. Encryption module 108 produces a cyphertext data box 112. This is denoted in FIG. 3 as cyphertext data block (1) since the first encryption module 108 may parse the data during execution depending on the size of the original message. Cyphertext data block (1) is passed to second encryption module 114, which again encrypts according to a pre-defined encryption scheme as discussed above. Second encryption module 110 likewise generates the second cyphertext data 114, denoted as cyphertext data block (2).

Optionally, as discussed below with reference to the cryptographic system embodiment of FIG. 6, the second cyphertext data block 114 may be passed to an application layer SSL prior to delivery down the protocol stack. This is represented in FIG. 3 which shows that the cyphertext data block (2) may be broken down into a plurality of fragments identified as cyphertext fragments (1)-(4). FIG. 3 only carries forward with the explanation as it relates to a selected one of the cyphertext fragments, namely cyphertext fragment (1) designated by the numeral 302. A similar process, of course, would occur as to the remaining cyphertext fragments (2)-(4). Is should also be readily apparent to the ordinarily skilled artisan that the diagrammatic view of FIG. 3, as it relates to the SSL implementation, only depicts data flow according to the SSL record protocol. That is, it is to be understood that FIG. 3 only depicts the transfer phase of the SSL protocol, otherwise known as the record protocol, and not the handshake phase which would have taken place earlier between the sending computer system and the server in order to negotiate cryptographic and exchange a secure session key.

With this in mind, once the data stream to be transmitted is broken into a series of fragments, as illustrated, each is independently protected and transmitted. The difference, of course, with the present invention is that the underlying data has already encountered two levels of encryption, according to two different encryption schemes, prior to even being impacted by the SSL record protocol. This makes in theoretically impossible to decipher the underlying plaintext message, even by the administrator. Accordingly, the added application layer SSL implementation effectuates yet a third layer of encryption to the data payload. To provide integrity protection, a message authentication code (MAC) 304 is computed over cyphertext data fragment 302. As well documented in the art the MAC will be transmitted along with cyphertext fragment 302 and verified by the receiving computer system 152 in FIG. 1. The MAC is appended to fragment 302 and the concatenated datagram 306 is encrypted by an SSL encryption module 308 according to known techniques to form an encrypted data payload 310. The particular encryption scheme implemented by the SSL encryption module 308 is in accordance with the parameters previously negotiated during the SSL handshake.

A record header is prepended to payload 310 and this concatenated record header 312 and encrypted payload 310 are referred to herein as SSL record 314. SSL record 314 is then delivered down the protocol stack to transport layer 204 and becomes a TCP data payload, to which is prepended a TCP header 316, thereby creating a TCP datagram 318. TCP datagram 318 becomes the data payload for the Internet layer 206. An IP header 320 is prepended to this and the concatenated IP data payload 318 and IP header 320 becomes an IP datagram 322. IP datagram 322 is delivered down the stack to network layer 208 and becomes the network data payload. A network header 324 is prepended to payload 322 to form a network datagram 326 for routing along the rest of the network architecture to the receiving computer system. The reversal of this takes place at the receiving computer system, all in accordance with known techniques, such that further explanation of the process is not needed in order for the ordinarily skilled artisan to fully appreciated the fragmentation and encryption process illustrated in FIG. 3, as well as the de-fragmentation and decryption to occur at the receiving host.

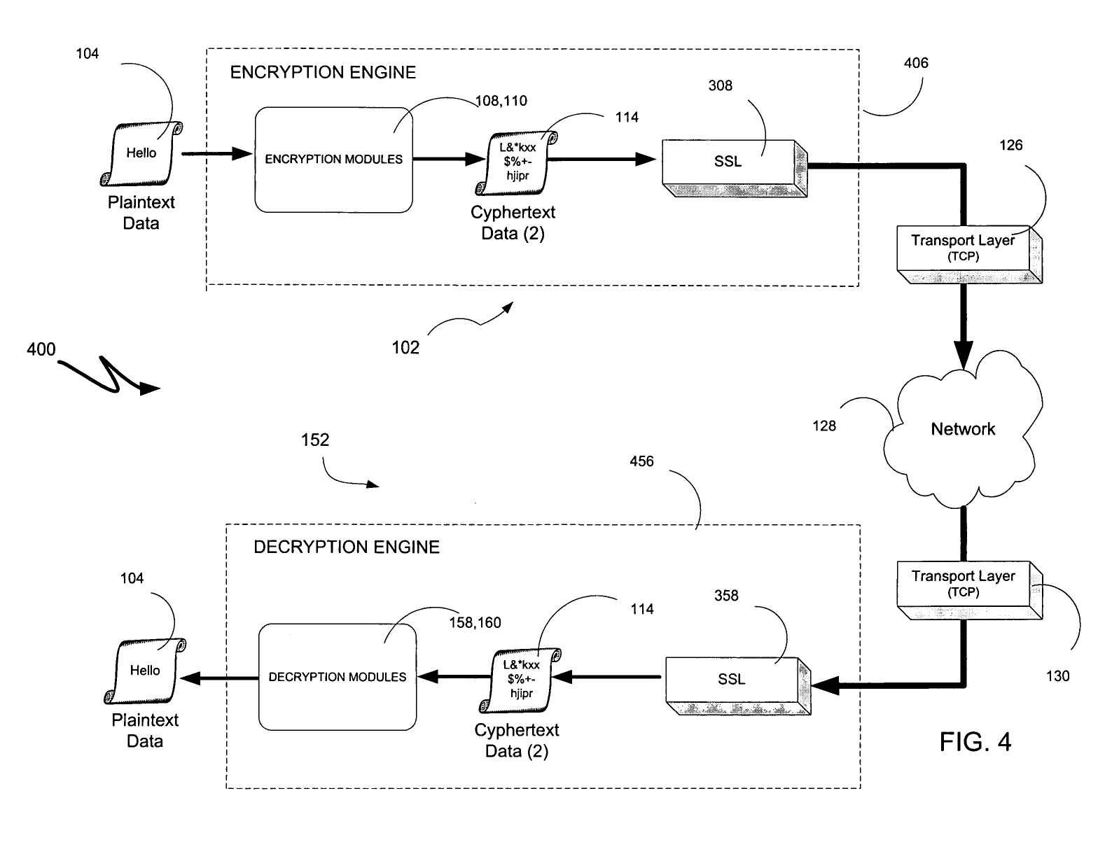

With an understanding of FIG. 3, an alternative construction for a cryptographic system may be advantageously provided as mentioned above, and as diagrammatically illustrated in FIG. 4. Here cryptographic system 400 has an associated encryption engine 406 at the sending computer system 402 for preparing plain text data 104 for enciphered transmission. As with cryptographic system discussed above, engine 406 incorporates encryption modules 108, 110 which convert the plain text data 104 into second cyphertext data 114. Additionally, however, encryption engine 406 incorporates the SSL encryption module 308 discussed above with reference to FIG. 3 so that encryption engine 406 provides 3 tiers of encryption at the application layer. For purposes of distinction, the cyphertext data leaving SSL encryption module 308 can be referred to as third cyphertext data (not depicted). This third cyphertext data correlated to the original plain text message 104 is then delivered to the TCP transport layer 126 and ultimately to the receiving computer system 152 as discussed above. Receiving computer system 152 has a corresponding decryption engine 456, also at its application layer, so that incoming third cyphertext data is reverted to second cyphertext data 114 via SSL decryption module 358 and then to plain text data 104 after sequentially passing through decryption modules 158, 160 discussed above.

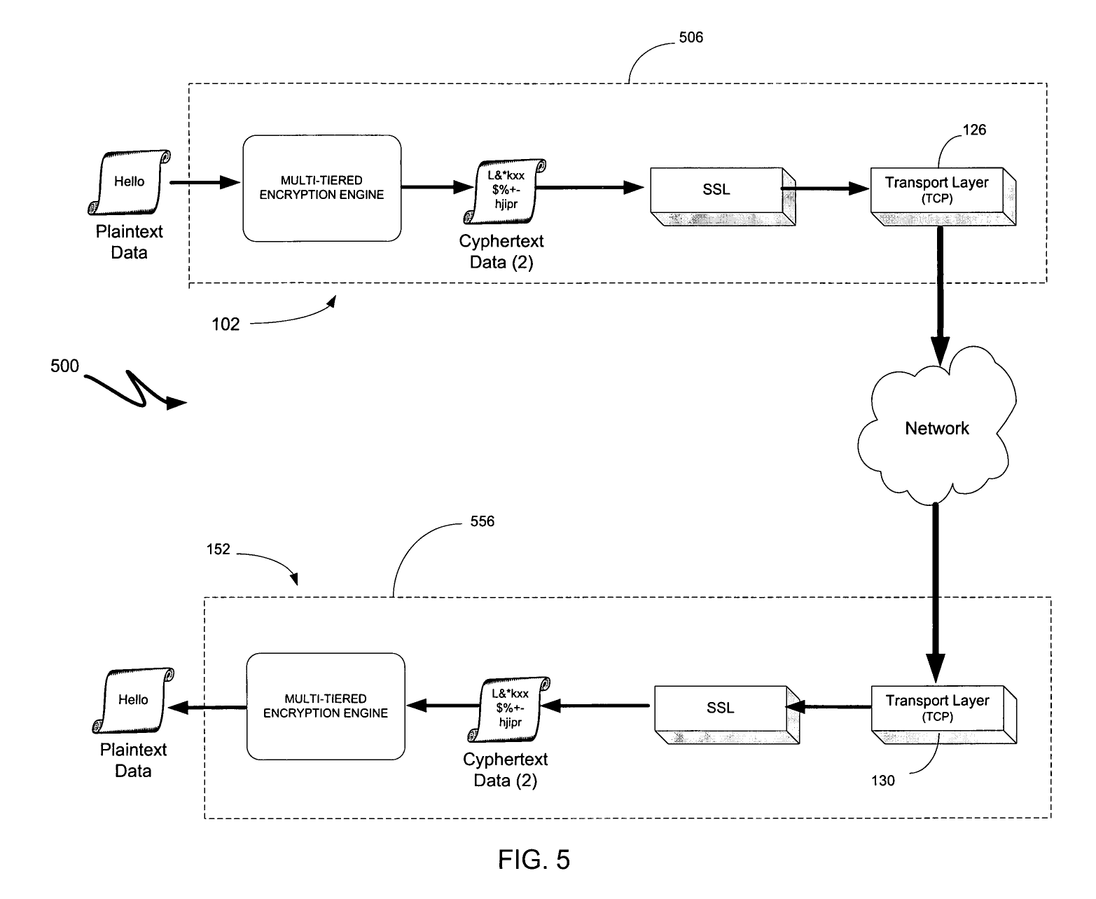

A third exemplary embodiment for a cryptographic system 500, as mentioned above, may be better appreciated with reference to FIG. 5. This embodiment for cryptographic system 500 contemplates that, in addition to the triple-tiered encryption and decryption which occurs, respectively, at the application layers of both the sending and receiving computer systems 102, 152, program engines may also provide for yet another layer of encryption at the transport layer in accordance with a secure exchange transport protocol (SETP) referred to above. More particularly, it may be seen that an associated encryption engine 506 of sending computer system 102 may deliver cyphertext data from the SSL encryption module to a secure transport layer whereby at least certain header fields, other than the source and destination IP addresses, may be encrypted prior to transmission along the network wire to receiving computer system 152. Receiving computer system 152 similarly operates in accordance with a secure transport layer and delivers received packets up the protocol stack to the SSL encryption module and the remaining decryption modules. While the secure transport layer implementation depicted in FIG. 5 is not presently preferred due to lack of industry awareness, it is anticipated that such a capability will eventually be well received and distributable as part of operating system installations as with existing protocols.

With an appreciation of the various advantageous embodiments for cryptographic systems which are contemplated, reference is now made to FIG. 6 which globally depicts such permutations, in a two-way cryptographic communication system 600. As such, cryptographic system 600 provides for multi-tiered encryption/decryption engines 606 and 656, respectively, associated with first computer system 102 and second computer system 152. Each of the encryption/decryption engines is capable of both encrypting plain text data 104 into cyphertext data 115 for delivery to the transport layer, as well as the reversion of incoming cyphertext data 115 into plain text data 104.

While the present invention may be implemented on a rather rudimentary network architecture, its preferred implementation such as with the instant messaging application particularly discussed in parent application Serial No. 10/200,014, is on a client/server network infrastructure wherein each client network has an associated client engine stored thereon for implementing encryption and decryption in accordance with the various embodiments discussed above. These application programs can be distributed as part of the operating system or otherwise, and could even provide for the capability of bypassing one or more of the encryption modules as desired.

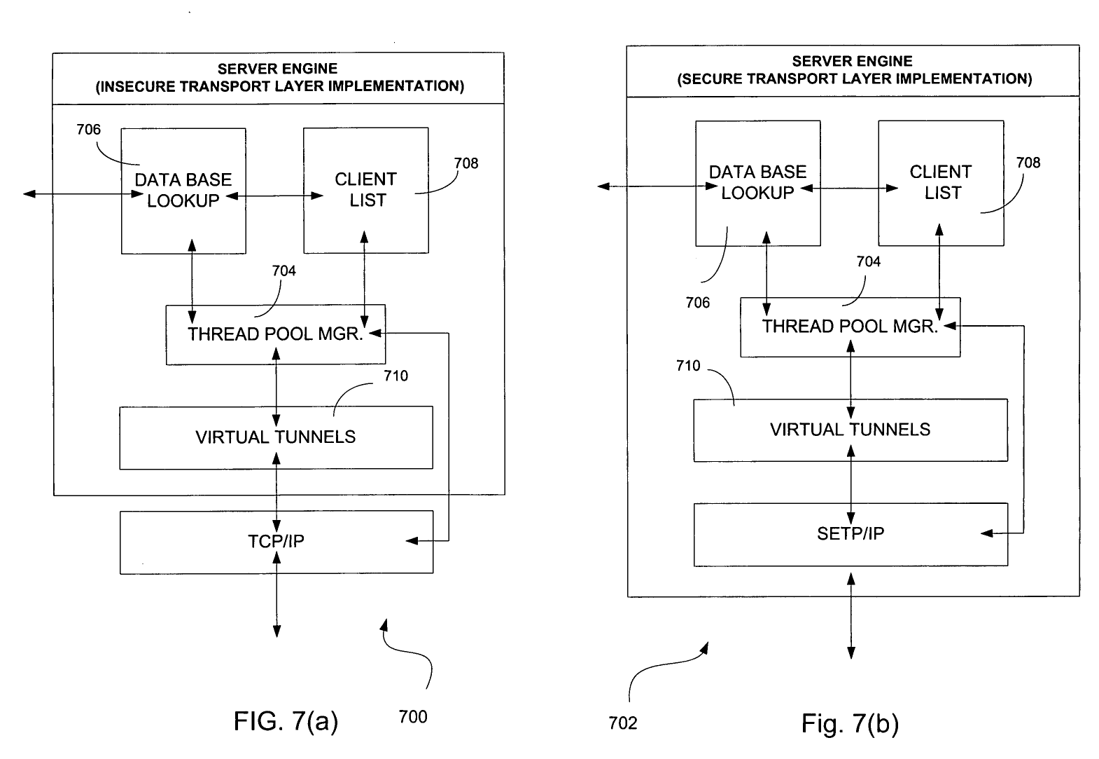

As for the server engine, two possibilities are illustrated in FIGS. 7(a) and 7(b), which respectively show server engines adapted for use with insecure and secure transport layer implementations. In FIG. 7(a), a server engine 700 is depicted which is adapted for use with an insecure transport layer implementation. In FIG. 7(b) an associated server engine 702 is depicted for use with a secure transport layer implementation. Common to each of these server engines is a thread pool manager 704 for keeping track of all of the threads of the application. The thread pool manager in the exemplary embodiment is a Boland compiler code component which can be implemented through an appropriate function call with the server's application program. The thread pool manger 704 is used in conjunction with a linked list of clients, such as TSimpleClient C++ objects which are Boland compiler specific.

Database lookup 706 is provided to lookup user ID's and ensure they are valid users. The database of valid users would be maintained by the administrator. A client list 706 is also provided. Client list 708 contains identities of all clients who can connect to the server, and is maintained in memory on the server since constant database lookups can be resource intensive.

Each of server engines 700 and 702 also provides for virtual tunneling 710 for the particular purpose of file transfers. It is preferred not to have to establish a new connection in order to send a file, as would otherwise occur with FTP, so that users can utilize an existing connection within the server to transfer files back and forth. To accomplish this, virtual tunneling is employed to, in essence, pretend or spoof another connection between the sender and receiver. With a virtual tunnel established between the sending and receiving computer systems, the server does not have to analyze every packet that goes by, which can reduce efficiency. Virtual tunneling also adds security to the message transfer system because, unlike existing schemes, it does not entail a plurality of ports to be opened, which adds inherent vulnerabilities from a security standpoint.

This virtual tunnel is created within the server's running memory and establishes a virtual connection between the two clients. What is meant by this is that when the client wishes to send a file to another client, a command is issued transparently to the server requesting the virtual connections between the two clients. Upon receipt of the message, the server finds the connection of the recipient from within the connection thread manager. The server application then spawns a new thread of execution (TidPeerThread which is a Boland compiler object code) and allocates the proper amount of memory to handle the file transfer. Once the thread has been initialized, the tunnel is now established. The virtual connection lies within the spawned thread and reads from the client sending the file, and writes to the client receiving the file utilizing ReadStream and WriteStream functions, respectively, which are also Borland compiler object codes.

While it is preferred to implement at least two tiers of encryption/decryption in the preferred embodiments of the present invention, the preferred order in which the asymmetric encryption and pass phrase-initiated encryption are performed depends on the particular type of message being transmitted. Up to this point the first layer of encryption and first layer of decryption have been described in the context of asymmetric cryptography, while the second layer of encryption and second layer of decryption have been described in the context of pass phrase-initiated cryptographic schemes. This is the preferred ordered approach when, for example, the message to be transmitted is an instant message. However, when it is desirable to transfer a file, it is preferred, for reasons of operating efficiency, to have the encryption and decryption schemes reversed. Moreover, as discussed above with reference to FIGS. 7(a) and 7(b), the preferred methods by which the file transfer between two clients occurs is not with in the conventional methods of such a protocol as FTP or even that of the peer-to-peer networks.

When two clients establish a connection with a server, that is the only connection utilized during any given session. The term “connection” in this context is defined as an established communication method between two entities utilizing an application socket, and a protocol stack. The term “session” in this context is the time from which a client connects to the server until the time in which the client disconnects from the server. The particular application in the parent case, for example, is an instant messaging application which needs a connection to communication with other clients. It utilizes a socket upon initialization of the network protocol to establish a connection with the server. The socket is a numeric value used by the operating system (and application) to keep track of open connection with other entities.

Certain network operations can be performed on a socket based on established standards, such as read and write. In the case of the file transfer mechanism of the present invention, the encrypted file (i.e. the output of the second encryption module) is the binary input of a WriteLn function. This function is supplied by the Borland C++ Builder© compiler as part of the TCPClient class, also part of the Borland's C++ Builder© compiler. This function uses the already existing connection (via the open socket) with the server established when the application was initialized.

It is desirable to have enhanced security for file exchange without the need for separate file transfer protocol. The idea behind it was that users should be able to use an existing connection with a server to transfer files back and forth. This, however, led to enhanced security questions, as another user who may be connected to the network could easily capture the traffic going back and forth on the wire. The solution was to add another “fast” encryption scheme to the engine that was set by a valid server administrator of the network. The encryption scheme for this layer is implementation independent. The server administrator would select from a list of various encryption schemes and would distribute certificates via the server engine as the valid clients connect for the first time.

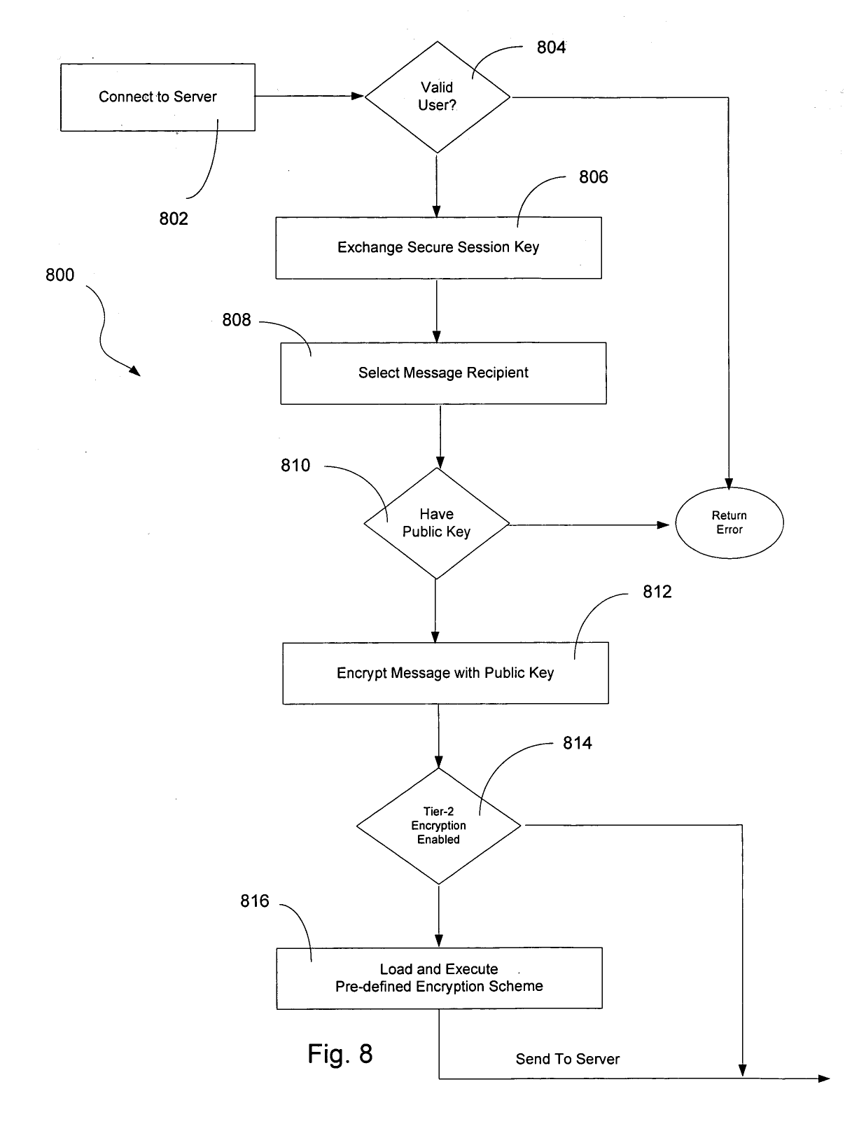

With the above in mind, a high level flow chart 800 is shown in FIG. 8 to illustrate the encryption methodology, as representatively shown from the sending computer system's perspective, in order to prepare for enciphered message transmission. Methodology 800 incorporates the use of SSL, which as discussed above is optional. In any event, an authorized user of the sending computer system, (referred to as “User A”) connects to the server at 802. Assuming the server recognizes at 804 that user “A” is a valid user of the pertinent system resources, the server establishes a secure connection with User A and at 806 exchanges the session key during an SSL handshake. Once the SSL session key has been exchanged and User A identifies another valid user, “User B”, as a message recipient at 808, a determination 810 is made as to whether User A's system has User B's public key. Assuming this to be the case, User A's computer system encrypts the message at 812 with the User B's public key, thus corresponding to the asymmetric encryption approach discussed above. The second tier encryption module is then enabled at 814 if it has been selected. The pre-defined encryption scheme is loaded at 816 to further encrypt the message, after which it is sent to the server and ultimately delivered to the receiving computer system.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A method of preparing a message for enciphered transmission over a network architecture from a sending computer system to a receiving computer system which are adapted to communicate according to a layered communications protocol that is characterized by a protocol stack, comprising:
a. at the sending computer system:
i. receiving, from an application program, plaintext data corresponding to said message;
ii. passing the plaintext data to a multi-tiered encryption engine stored on the sending computer system;
iii. encrypting said plaintext data within said encryption engine according to a first encryption scheme, thereby to generate first ciphertext message data; and
iv. encrypting said first ciphertext message data within said encryption engine according to a second encryption scheme, thereby to generate second ciphertext message data intended for transmission to the receiving computer system in accordance with the layered communications protocol.

2. A method according to claim 1 comprising delivering said second ciphertext data to a transport layer associated with the layered communications protocol.

3. A method according to claim 1 whereby said first encryption scheme comprises asymmetric cryptography.

4. A method according to claim 1 whereby said first encryption scheme comprises encrypting the plaintext data according to a first encryption algorithm which utilizes a first encryption key associated with a user of the receiving computer system.

5. A method according to claim 3 whereby said first encryption key is a public key associated with an authorized user of the receiving computer system.

6. A method according to claim 1 whereby entry of a selected pass phrase is required to initiate said second encryption scheme.

7. A method according to claim 1 whereby said second encryption scheme is implemented in accordance with a pre-defined cryptographic scheme that includes a pre-defined second encryption algorithm, said pre-defined cryptographic scheme residing on the sending computer system.

8. A method according to claim 7 whereby a pre-defined pass phrase is required to initiate said pre-defined second encryption algorithm.

9. A method according to claim 1 whereby said second encryption scheme is characterized by an associated second encryption algorithm that is selected from a set of encryption algorithms stored on said sending computer system.

10. A method according to claim 9 whereby said set of encryption algorithms is selected from a group consisting of 3DES, RC4, Blowfish, Twofish, AES and DES.

11. A method according to claim 1 whereby said first encryption scheme is characterized by an associated first encryption algorithm and first encryption key, said first encryption key being unique to an authorized user of the receiving computer system.

12. A method according to claim 1 wherein said layered communications protocol is the layered TCP/IP protocol suite, whereby each of said first and second encryption schemes is implemented at the application layer of the TCP/IP protocol suite, and whereby said second ciphertext message data is delivered down the protocol stack to the transport layer so that it can be transmitted to the receiving computer system in accordance with said communications protocol.

13. In a method of communicating enciphered message data from a sending computer system to a receiving computer system according to a layered communications protocol, wherein said layered communications protocol is of a type which implements a security protocol to provide a secure channel for communicating between the sending and receiving computer systems, the improvement comprising implementation of a multi-tiered encryption engine at the application layer of the sending computer system whereby plaintext data intended for transmission to the receiving computer system is sequentially encrypted by a plurality of encryption modules prior to being transmitted to a transport layer and ultimately to the receiving computer system in accordance with said layered communications protocol.

14. The improvement according to claim 13 whereby each of said first and second encryption modules is implemented in user space on the sending computer system.

15. The improvement according to claim 14 whereby said first encryption module executes a first encryption scheme characterized by a first encryption algorithm and a first encryption key that is unique to an authorized user of the receiving computer system, and whereby said second encryption module executes according to a pre-determined encryption scheme stored on the sending computer system.

16. The improvement according to claim 15 whereby said pre-determined encryption scheme is initiated by entry of a pass phrase that resides on both the sending computer system and the receiving computer system.

17. The improvement according to claim 14 whereby each of said first and second encryption modules executes according to respective first and second encryption algorithms, and whereby each of said first and second encryption algorithms is selected from a database of encryption algorithms stored in a dynamically linked library on the sending computer system.

18. A cryptographic system for permitting enciphered message transmission between a first computer system and a second computer system on a network architecture, wherein the first and second computer systems are adapted to communicate according to a layered communications protocol that is characterized by a protocol stack, said system comprising:
a. a multi-tiered encryption engine implemented on said first computer system, said encryption engine including:
i. a first encryption module for receiving, from an application program, plaintext data corresponding to a message that is intended for transmission to said second computer system and for converting the plaintext data to first ciphertext data according to a first encryption scheme; and
ii. a second encryption module for converting said first ciphertext data to second ciphertext data according to a second encryption scheme and for delivering said second ciphertext data down the protocol stack to a transport layer so that said second ciphertext data can be transmitted along a communication channel to the second computer system according to said layered communications protocol; and
b. a multi-tiered decryption engine implemented on the second computer system, said decryption engine comprising:
i. a first decryption module for receiving said second ciphertext data from the transport layer of the second computer system and for reverting said second ciphertext data to said first ciphertext data according to a first decryption scheme; and
ii. a second decryption module for reverting said first ciphertext data to said plaintext data according to a second decryption scheme and for delivering said plaintext data up the protocol stack to an application program accessible by the second computer system.

19. A cryptographic system according to claim 18 wherein said first encryption module and said second decryption module are implemented according to a common first cryptographic scheme.

20. A cryptographic system according to claim 19 wherein said message is in a form other than a file, and wherein said common first cryptographic scheme is asymmetric cryptography.

21. A cryptographic system according to claim 20 wherein said second encryption module and said first decryption module are implemented according to a common second cryptographic scheme.

22. A cryptographic system according to claim 21 wherein said message is a file, and wherein said common second cryptographic scheme is asymmetric cryptography.

23. A cryptographic system according to claim 18 wherein said first encryption module and said second decryption module are implemented according to an asymmetric cryptographic scheme, and wherein second encryption module and said first decryption module are implemented according to a pass phrase initiated cryptographic scheme.

24. A cryptographic system according to claim 18 wherein a corresponding said multi-tiered decryption engine is stored for execution on said first computer system and wherein a corresponding said multi-tiered encryption engine is stored for execution on said second computer system, thereby to permit enciphered message transmission from said second computer system to said first computer system.

25. A multi-tiered encryption engine for use on a sending computer system that is adapted to transmit message data along a network architecture to a receiving computer system according to a layered communications protocol, said multi-tiered encryption engine comprising:
a. a first encryption module implemented in user space on the sending computer system for receiving plaintext data from an application program and for encrypting said plaintext message data according to a first encryption scheme that utilizes a public key associated with an authorized user of the receiving computer system, thereby to generate first ciphertext data; and
b. a second encryption module implemented in user space on the sending computer system for encrypting said first cyphertext data, according to a second encryption scheme that is initiated in response to entry of a required pass phrase, thereby to generate second ciphertext message data intended for transmission to the receiving computer system in accordance with the layered communications protocol.

26. A multi-tiered encryption/decryption engine for use on a client computer system that is adapted to transmit and receive message data along a network architecture to and from other computer system according to a layered communications protocol, said multi-tiered encryption engine comprising:
a. a first encryption tier implemented in user space on the client computer system for receiving plaintext message data from an application program and for encrypting said plaintext message data according to a first encryption scheme to generate first ciphertext data; and
b. a second encryption tier implemented in user space on the client computer system for receiving plaintext message data from an application program and for encrypting said first cyphertext message data according to a second encryption scheme to generate second ciphertext data for delivery to a transport layer associated with said layered communications protocol.

27. A computerized method for enciphered message transmission, along a network architecture which implements TCP/IP, from a sending client computer system to a receiving client computer system, each being logged on to a common network server, said computerized method comprising:
a. at the sending computer system:
i. obtaining plaintext data corresponding to a message;
ii. identifying the receiving computer system as an intended recipient of the message;
iii. confirming that the receiving computer system is valid;
iv. passing the plaintext data to a multi-tiered encryption engine;
v. encrypting said plaintext data within said encryption engine according to a first encryption scheme, thereby to generate first ciphertext message data; and
vi. encrypting said first ciphertext message data within said encryption engine according to a second encryption scheme, thereby to generate second ciphertext message data; and
vii. passing said second ciphertext message data down a protocol stack to a TCP/IP transport layer;
b. transmitting the second ciphertext message data, via said server, from the sending computer system to the receiving computer system in accordance with TCP/IP; and
c. at the receiving computer system:
i. passing the second ciphertext data up a protocol stack from TCP/IP to an application layer, multi-tiered decryption engine;
ii. reverting said second ciphertext data within said decryption engine to said first ciphertext data according to a first decryption scheme;
iii. reverting said first ciphertext data within said decryption engine to said plaintext data according to a second decryption scheme; and
iv. delivering said plaintext data an application program accessible by the receiving computer system.
